(19) United States
(12) Patent Application Publication
(10) Pub. No.: US 2019/0360350 A1
(43) Pub. Date: Nov. 28, 2019

(54) AXIAL FLOW ROTATING MACHINE, AND ROTOR BLADE MEMBER

(71) Applicant: MITSUBISHI HEAVY INDUSTRIES, LTD., Tokyo (JP)

(72) Inventors: Masataka Mori, Tokyo (JP); Shinji Fukao, Tokyo (JP); Hideaki Sugishita, Tokyo (JP); Kazuyuki Matsumoto, Tokyo (JP); Yoshihiro Kuwamura, Tokyo (JP)

(73) Assignee: MITSUBISHI HEAVY INDUSTRIES, LTD., Tokyo (JP)

(21) Appl. No.: 16/485,547

(22) PCT Filed: Feb. 16, 2018
(86) PCT No.: PCT/JP2018/005476

§ 371 Date: Aug. 13, 2019

(30) Foreign Application Priority Data
Feb. 17, 2017 (JP) 2017-027928

(51) Int. Cl. F01D 11/00; F01D 11/02; F01D 5/20; F01D 9/04; F02C 7/28; F01D 1/04; F01D 1/20

(52) U.S. Cl. CPC F01D 11/001; F01D 11/02; F01D 5/20; F01D 9/041; F05D 2260/6022; F01D 1/04; F01D 1/20; F05D 2240/12; F05D 2240/55; F02C 7/28

(57) ABSTRACT

A steam turbine includes a rotating shaft (1); a rotor blade (4) having a platform (43) and a rotor blade main body (40); a casing (2); a stationary blade (7) having a stationary blade main body (70) and a stator shroud (71); and a projecting portion (45A) that projects from the platform (43) toward a upstream side in a central axis direction (Da). The projecting portion (45A) has, on a side thereof facing a radially inner side, a guide surface (45f) that gradually inclines or curves radially inward from a base end portion (45s) on the platform (43) side to a tip end portion (45t) on an upstream side in the central axis direction (Da).

### TECHNICAL FIELD

The present invention relates to an axial flow rotating machine and a rotor blade member. Priority is claimed on Japanese Patent Application No. 2017-027928, filed Feb. 17, 2017, the content of which is incorporated herein by reference.

### BACKGROUND ART

In axial flow rotating machines, such as a steam turbine and a gas turbine, one is known including a casing, a rotating shaft that is provided inside the casing, a stationary blade that is fixedly disposed at an inner peripheral part of the casing, and a rotor blade that is radially provided in the rotating shaft on a downstream side of this stationary blade.

For example, in the case of the steam turbine, steam pressure energy is converted into speed energy by the stationary blade, and the speed energy is converted into rotational energy (mechanical energy) by the rotor blade. Additionally, there is a case where the pressure energy is converted into the speed energy within the rotor blade, and is converted into the rotational energy (mechanical energy) due to a reaction force jetted from steam.

In this type of rotating machine, a gap in a radial direction is formed between a tip end portion of the stationary blade, and the rotating shaft. A working fluid, such as steam, may pass (leak) through this gap. The working fluid, which passes through the gap between the tip end portion of the stationary blade, and the rotating shaft, does not contribute to the conversion of the pressure energy into the speed energy that is caused by the stationary blade, and hardly apply a rotative force to the rotor blade on the downstream side. Hence, in order to improve the performance of the rotating machine, it is important to reduce the amount of leak steam which passes through the gap.

As a technique for reducing the amount of leakage of the working fluid, for example, PTL 1 discloses a configuration in which a rotor blade hub that faces a stator shroud in an axis direction is provided with a suppression plate that projects toward the upstream side.

### CITATION LIST

### Patent Literature

[PTL 1] Japanese Unexamined Patent Application, First Publication No. 2005-146977

### DISCLOSURE OF INVENTION

### Technical Problem

However, in the configuration described in above PTL 1, a gap in an axis direction is formed between a tip end portion on the upstream side of the suppression plate, and the stator shroud. For this reason, leakage of the working fluid occurs through the gap between the tip end portion of this suppression plate, and the stator shroud. In addition, a leak flow of the working fluid, which has passed through the gap between the tip end portion of the suppression plate, and the stator shroud, is directed from an inner side toward an outer side in the radial direction of the rotating shaft due to a centrifugal force caused by the rotation of the rotating shaft, and joins so as to intersect a main flow of the working fluid that flows in the axis direction. It is known that, in a case where the main flow of the working fluid and the leak flow of the working fluid intersect each other to collide against and be mixed with each other, energy loss referred to as mixed loss occurs. There is a case where an increase in the mixed loss hinders improvement in efficiency of the axial flow rotating machine.

An object of the invention is to provide an axial flow rotating machine and a rotor blade member in which mixed loss between a main flow of a working fluid and a leak flow of the working fluid is reduced, and the performance of the axial flow rotating machine is improved.

### Solution to Problem

The invention adopts the following means in order to solve the above problem.

A first aspect of the invention includes a rotating shaft that is configured to rotate around a central axis; a rotor blade that has a platform provided on a radially outer side of the rotating shaft and a rotor blade main body provided so as to extend radially outward from the platform; a tubular casing that is disposed radially outside the rotating shaft and the rotor blade and through which a working fluid flows from an upstream side toward a downstream side in a central axis direction on a radially inner side thereof; a stationary blade that has a stationary blade main body provided on an upstream side in the central axis direction with respect to the rotor blade and provided so as to extend radially inward from the casing, and a stator shroud provided on a radially inner side of the stationary blade main body; and a projecting portion that projects from the platform toward the upstream side in the central axis direction. The projecting portion has, on a side thereof facing the radially inner side, a guide surface that gradually inclines or curves radially inward from the platform toward the upstream side in the central axis direction from a base end portion on the platform side to a tip end portion on the upstream side in the central axis direction.

According to such a configuration, a leak flow of the working fluid, which flows from the inner side toward the outer side in the radial direction through a gap (cavity) between the stator shroud and the platform of the rotor blade, hits the guide surface that is formed on the radially inner side of the projecting portion. Since the guide surface gradually inclines or curves radially inward from the base end portion on the platform side to the tip end portion on the upstream side, the leak flow of the working fluid generates a vortex so as to be returned radially inward by the guide surface. By the vortex being generated in this way, the flow of the leak flow from the outer side to the inner side in the radial direction is dissipated. Accordingly, the leak flow, which flows out outward in the radial direction from the gap between the stator shroud and the platform of the rotor blade, becomes weaker. As a result, the mixed loss when the leak flow of the working fluid joins a main flow of the working fluid that alternately passes through the stationary blade main body and the rotor blade main body in the central axis direction inside the casing is reduced.

A second aspect of the invention based on the above first aspect may further include a shroud recess that is formed in the stator shroud, faces the projecting portion in the central axis direction, and is recessed toward the upstream side in the central axis direction.

According to such a configuration, a portion of the leak flow of the working fluid, which flows from the inner side toward the outer side in the radial direction through the gap between the stator shroud and the platform of the rotor blade, flows into the shroud recess that faces the projecting portion along the guide surface of the projecting portion. The leak flow of the working fluid becomes weaker by flowing into the shroud recess. As a result, the mixed loss when the leak flow joins the main flow of the working fluid is further reduced.

In a third aspect of the invention based on the above second aspect, an outer peripheral wall surface of the shroud recess, which is located on the radially outer side, may gradually incline or curve radially outward from the upstream side toward the downstream side in the central axis direction.

According to such a configuration, the leak flow of the working fluid, which has flowed into the shroud recess, is gradually guided radially outward from the upstream side toward the downstream side in the central axis direction along the outer peripheral wall surface of the shroud recess. Accordingly, the angle at which the leak flow of the working fluid intersects the main flow of the working fluid is smaller than a right angle. As a result, the mixed loss when the leak flow joins the main flow of the working fluid is further reduced.

In a fourth aspect of the invention based on the above second or third aspect, the projecting portion may have, on a side thereof facing the radially outer side, an outer peripheral guide surface that gradually inclines or curves radially outward from the upstream side toward the downstream side in the central axis direction.

According to such a configuration, the leak flow of the working fluid, which has flowed out from the shroud recess to the downstream side, flows along the outer peripheral guide surface of the projecting portion. Accordingly, the leak flow of the working fluid is gradually guided radially outward from the upstream side toward the downstream side in the central axis direction. Accordingly, the angle at which the leak flow of the working fluid intersects the main flow of the working fluid is made small, and the mixed loss when the leak flow of the working fluid joins the main flow of the working fluid is further reduced.

In a fifth aspect of the invention based on the above second to fourth aspects, when the rotating shaft and the rotor blade are relatively displaced in the central axis direction with respect to the stationary blade, at least a portion of the projecting portion may be insertable into the shroud recess.

According to such a configuration, in a case where the rotating shaft and the rotor blade thermally elongate in the central axis direction more than the stationary blade due to the heat of the working fluid, at least a portion of the projecting portion is inserted into the shroud recess. Accordingly, interference between the projecting portion and the stator shroud can be suppressed.

In a sixth aspect of the invention based on the above fifth aspect, a projection dimension of the projecting portion in the central axis direction from the platform may be equal to or less than a recessed dimension of the shroud recess in the central axis direction.

According to such a configuration, interference between the projecting portion and the shroud recess can be suppressed even if the entire projecting portion is inserted into the shroud recess.

A seventh aspect of the invention based on the above first to sixth aspects may further include an inner peripheral projecting portion that is formed radially inside the projecting portion and projects from the stator shroud to the downstream side in the central axis direction.

According to such a configuration, the leak flow of the working fluid, which flows from the inner side toward the outer side in the radial direction through the gap between the stator shroud and the platform of the rotor blade, hits the inner peripheral projecting portion radially inside the projecting portion. Accordingly, the flow of the leak flow of the working fluid from the inner side to the outer side in the radial direction is further dissipated. As a result, the mixed loss when the leak flow of the working fluid joins the main flow of the working fluid is further reduced.

An eighth aspect of the invention based on the above seventh aspect, may further include a platform recess that is formed in the platform, faces the inner peripheral projecting portion in the central axis direction, and is recessed toward the downstream side in the central axis direction.

According to such a configuration, a portion of the leak flow of the working fluid, which has hit the inner peripheral projecting portion, flows into the platform recess that faces the inner peripheral projecting portion. The leak flow of the working fluid becomes weaker by flowing into the platform recess. As a result, the mixed loss when the leak flow joins the main flow of the working fluid is further reduced.

A ninth aspect of the invention includes a rotor blade member including: a platform that is provided on a radially outer side of a rotating shaft; a rotor blade main body that is provided so as to extend radially outward from the platform; and a projecting portion that projects from the platform toward an upstream side of the rotating shaft in a central axis direction. The projecting portion has, on a side thereof facing a radially inner side, a guide surface that gradually inclines or curves radially inward from a base end portion on the platform side to a tip end portion spaced in the central axis direction.

According to such a configuration, the rotor blade member of the above configuration is assembled into the axial flow rotating machine. Accordingly, the leak flow of the working fluid, which flows out radially outward from the gap between the stator shroud and the platform of the rotor blade, can be weakened. As a result, the mixed loss when the leak flow of the working fluid joins a main flow of the working fluid that alternately passes through the stationary blade main body and the rotor blade main body in the central axis direction inside the casing can be reduced.

### Advantageous Effects of Invention

According to the above axial flow rotating machine and rotor blade member, the mixed loss between the main flow of the working fluid and the leak flow of the working fluid can be reduced, and the performance of the axial flow rotating machine can be improved.

### BRIEF DESCRIPTION OF DRAWINGS

FIG. 1 is a schematic view illustrating the configuration of a steam turbine related to embodiments of the invention.

FIG. 2 is an enlarged view of main parts of a steam turbine related to a first embodiment of the invention.

FIG. 3 is an enlarged view of main parts of a steam turbine related to a second embodiment of the invention.

FIG. 4 is an enlarged view of main parts of a steam turbine related to a modification example of the second embodiment of the invention.

FIG. 5 is an enlarged view of main parts of a steam turbine related to a third embodiment of the invention.

### BEST MODE FOR CARRYING OUT THE INVENTION

Hereinafter, an axial flow rotating machine and a rotor blade member related to an embodiment of the invention will be described on the basis of the drawings.

### First Embodiment

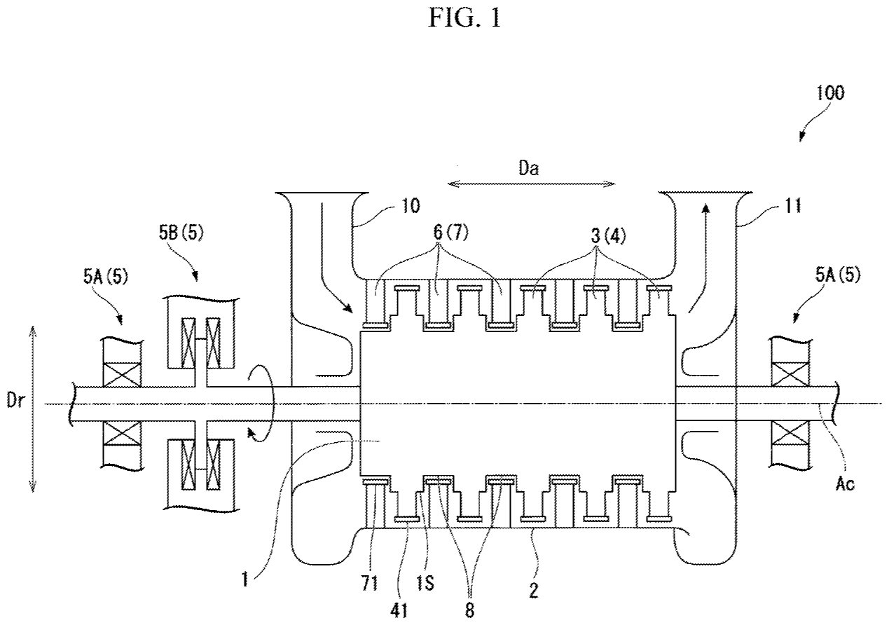

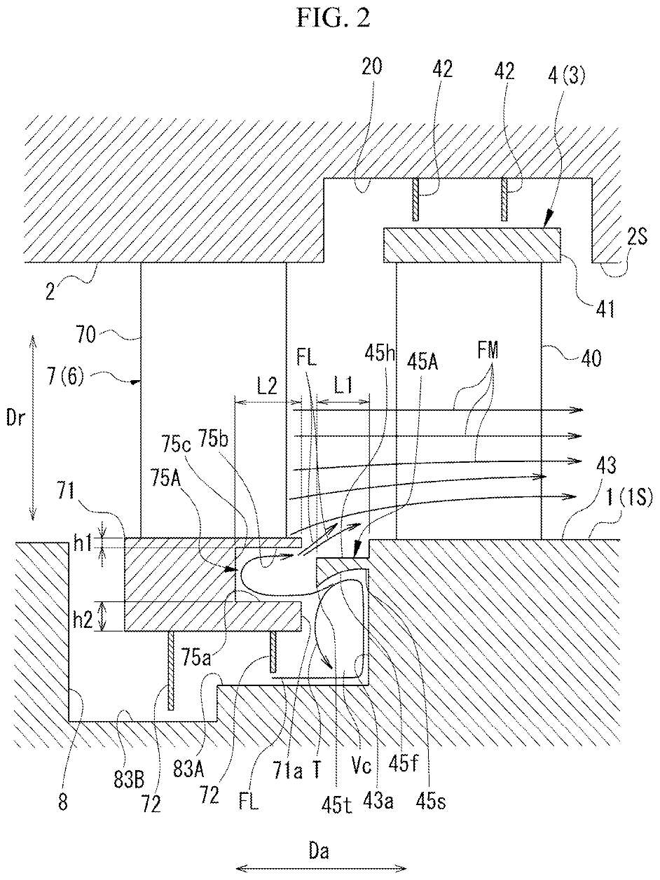

FIG. 1 is a schematic view illustrating the configuration of a steam turbine related to embodiments of the invention. FIG. 2 is an enlarged view of main parts of a steam turbine related to a first embodiment of the invention.

As illustrated in FIG. 1, a steam turbine (axial flow rotating machine) 100 related to the present embodiment includes a rotating shaft 1, a casing 2, a rotor blade row 3 including a plurality of rotor blades 4, and a stationary blade row 6 including a plurality of stationary blades 7.

The rotating shaft 1 has a columnar shape that extends along a central axis Ac. The rotating shaft 1 is supported such that both ends thereof in a central axis direction Da along the central axis Ac are rotatable around the central axis Ac by a bearing device 5. The bearing device 5 has a journal bearing 5A provided on each of both sides of the rotating shaft 1 in the central axis direction Da, and a thrust bearing 5B provided only on a first axis in the central axis direction Da. The journal bearing 5A supports a load in a radial direction Dr caused by the rotating shaft 1. The thrust bearing 5B supports a load in the central axis direction Da caused by the rotating shaft 1.

The casing 2 has a tubular shape that extends in the central axis direction Da.

The casing 2 covers the rotating shaft 1 from an outer peripheral side. The casing 2 includes an intake port 10 and an exhaust port 11. The intake port 10 is formed on the first axis of the casing 2 in the central axis direction Da and takes in steam (working fluid) into the casing 2 from the exterior. The exhaust port 11 is formed on a second side of the casing 2 in the central axis direction Da, and exhausts the steam, which passes through the interior of the casing 2, to the exterior.

In the subsequent description, the side in which the intake port 10 is located as seen from the exhaust port 11 is referred to as an upstream side, and a side in which the exhaust port 11 is located as seen from the intake port 10 is referred to as a downstream side.

A plurality of the rotor blade rows 3 are provided at intervals from the first axis toward the second side in the central axis direction Da on an outer peripheral surface 1S of the rotating shaft 1. Each rotor blade row 3 has a plurality of rotor blades (rotor blade members) 4 arranged at intervals in a circumferential direction around the central axis Ac on the outer peripheral surface 1S of the rotating shaft 1.

As illustrated in FIG. 2, each rotor blade 4 has a platform 43 provided in the outer peripheral surface 1S of the rotating shaft 1, a rotor blade main body 40, and a rotor shroud 41.

Although not illustrated in detail, the rotor blade main body 40 is formed so as to extend radially outward from the platform 43. The rotor blade main body 40 has an airfoil-shaped cross-section as seen from the radial direction Dr. The rotor shroud 41 is provided at a radially outer end of the rotor blade main body 40.

The rotor shroud 41 is set such that the dimension thereof in the central axis direction Da is larger than the dimension of the rotor blade main body 40 in the central axis direction Da.

A rotor blade housing recess 20 for housing the rotor shroud 41 is formed in a region, which faces the rotor shroud 41 in the radial direction Dr, on an inner peripheral side of the casing 2. The rotor blade housing recess 20 has a groove shape that is recessed outward in the radial direction Dr from the inner peripheral surface 2S of the casing 2 and is continuous in the circumferential direction around the central axis Ac.

A plurality of (two) rotor blade-side fins 42 are provided in the rotor blade housing recess 20. Each of the rotor blade-side fins 42 has a thin plate shape that extends inward in the radial direction Dr. A gap (clearance) that spreads in the radial direction Dr is formed between a tip end portion of the rotor blade-side fin 42 and the rotor blade housing recess 20.

As illustrated in FIG. 1, a plurality of the stationary blade rows 6, are provided at intervals in the central axis direction Da on the inner peripheral surface of the casing 2. Each stationary blade row 6 is disposed on the upstream side of each rotor blade row 3. Each stationary blade row 6 has the plurality of stationary blades 7 arranged at intervals in the circumferential direction around the central axis Ac.

As illustrated in FIG. 2, each stationary blade 7 includes a stationary blade main body 70 and a stator shroud 71.

The stationary blade main body 70 is provided so as to extend inward in the radial direction Dr from the inner peripheral surface 2S of the casing 2. The stationary blade main body 70 has an airfoil-shaped cross-section as seen from the radial direction Dr.

The stator shroud 71 is attached to an inner end of the stationary blade main body 70 in the radial direction Dr.

In the present embodiment, the dimensions of the stationary blade main body 70 and the rotor blade main body 40 in the radial direction Dr are equal. In other words, as seen from the central axis direction Da, the stationary blade main body 70 and the rotor blade main body 40 are arranged so as to overlap each other.

A grooved stationary blade housing recess 8, which is recessed inward in the radial direction Dr from the outer peripheral surface 1S of the rotating shaft 1 and is continuous in the circumferential direction around the central axis Ac, is formed on the upstream side of each rotor blade row 3 on the outer peripheral surface 1S of the rotating shaft 1 facing outward in the radial direction Dr. In this embodiment, the stationary blade housing recess 8 is formed such that a bottom surface 83A on the downstream side in the central axis direction Da is located closer to the inner side in the radial direction Dr than a bottom surface 83B on the upstream side.

The stator shroud 71 of each stationary blade 7 is housed within the stationary blade housing recess 8.

The stator shroud 71 is provided with a plurality of (two) stator-side fins 72. All the stator-side fins 72 have a thin plate shape that extends inward in the radial direction Dr from the stator shroud 71. The stator shroud 71 and the stator-side fins 72 are provided for the purpose of reducing leakage of the steam between the rotating shaft 1 and the stationary blade 7. The stator-side fin 72 located on the upstream side in the central axis direction Da between the two stator-side fins 72 faces the bottom surface 83B, and the stator-side fin 72 located on the downstream side faces the bottom surface 83A. The stator-side fins 72 and the bottom surfaces 83A and 83B face each other with a predetermined gap in the radial direction Dr.

Such a steam turbine 100 further includes a projecting portion 45A and a shroud recess 75A.

The projecting portion 45A is formed at an intermediate part, in the radial direction Dr, of an upstream end surface 43a of the platform 43.

The upstream end surface 43a is formed so as to be orthogonal to the central axis direction Da toward the upstream side in the central axis direction Da. The projecting portion 45A is formed so as to project from the upstream end surface 43a of the platform 43 toward the upstream side in the central axis direction Da.

In this embodiment, the projecting portion 45A has a guide surface 45f on a side facing inward in the radial direction Dr. The guide surface 45f is formed so as to gradually curve inward in the radial direction Dr with a certain curvature over the entire area from the base end portion 45s on the upstream end surface 43a side of the platform 43 to the tip end portion 45t spaced to the upstream side in the central axis direction Da. Additionally, in this embodiment, an outer surface 45h, which faces outward in the radial direction Dr, in the projecting portion 45A is formed orthogonal to the upstream end surface 43a and parallel to the central axis direction Da.

The shroud recess 75A is formed in a downstream wall surface 71a of the stator shroud 71. The downstream wall surface 71a is formed so as to be orthogonal to the central axis direction Da toward the downstream side in the central axis direction Da and face the upstream end surface 43a of the platform 43 with a gap in the central axis direction Da.

The shroud recess 75A is formed at a position facing the projecting portion 45A in the central axis direction Da so as to be recessed from the downstream wall surface 71a toward the upstream side in the central axis direction Da. In this embodiment, the shroud recess 75A is formed such that an inner peripheral wall surface 75a on the inner side in the radial direction Dr and an outer peripheral wall surface 75b on the outer side in the radial direction Dr are formed parallel to the central axis direction Da, respectively. In the shroud recess 75A, an upstream wall surface 75c on the upstream side in the central axis direction Da is formed orthogonal to the central axis direction Da.

Additionally, a thickness h1 in the radial direction Dr between the inner peripheral wall surface 75a and the surface of the stator shroud 71 that faces inward in the radial direction Dr is larger than a thickness h2 in the radial direction Dr between the outer peripheral wall surface 75b and the surface of the stator shroud 71 that faces outward in the radial direction Dr.

The shroud recess 75A is formed such that the inner peripheral wall surface 75a is located closer to the inner side in the radial direction Dr than the guide surface 45f of the projecting portion 45A. The outer peripheral wall surface 75b of the shroud recess 75A is formed closer to the outer side in the radial direction Dr than the outer surface 45h of the projecting portion 45A.

Here, there is a case where the casing 2, the stationary blade 7, the rotating shaft 1, the rotor blade 4, and the like thermally elongates in the central axis direction Da due to the heat transmitted from the steam during the operation of the steam turbine 100. Moreover, there is a case where thermal elongation amounts in the central axis direction Da are different from each other between the casing 2 and the stationary blade 7, and the rotating shaft 1 and the rotor blade 4.

In the shroud recess 75A, when the rotating shaft 1 and the rotor blade 4 are relatively displaced in the central axis direction Da with respect to the stationary blade 7 due to the difference between the above thermal elongation amounts, at least a portion of the projecting portion 45A is insertable into the shroud recess 75A.

Moreover, a projection dimension L1 of the projecting portion 45A in the central axis direction Da from the platform 43 is equal to or less than a recessed dimension L2 of the shroud recess 75A in the central axis direction Da. Accordingly, when the rotating shaft 1 and the rotor blade 4 are relatively displaced in the central axis direction Da with respect to the stationary blade 7, the entire projecting portion 45A is insertable into the shroud recess 75A.

The operation of the steam turbine 100 configured as described above will be described with reference to FIG. 1. In operating the steam turbine 100, high-temperature high-pressure steam first supplied from a steam supply source (not illustrated), such as a boiler, is introduced into the interior of the casing 2 through the intake port 10. The steam introduced into the casing 2 sequentially collides against the rotor blade 4 (rotor blade row 3) and the stationary blade 7 (stationary blade row 6). Accordingly, the rotating shaft 1 obtains rotational energy and rotates around the central axis Ac. A rotational movement of the rotating shaft 1 is taken out by a generator (not illustrated) coupled to a shaft end. The above cycle is continuously repeated.

The steam, which has flowed from the upstream side, alternatively passes through the stationary blade 7 and the rotor blade 4 and flows toward the downstream side to form a main flow FM. The main flow FM is straightened by sequentially colliding against the stationary blade 7 and the rotor blade 4 as described above, and gives energy to the rotor blade 4.

On the other hand, a component, excluding the main flow FM in the steam that has flowed from the upstream side, forms a leak flow FL by flowing toward the interior of the stationary blade housing recess 8. Most of the leak flow FL is blocked by the stator-side fins 72 provided on the stator shroud 71. However, since clearances are formed between the stator-side fins 72 and the bottom surfaces 83A and 83B of the stationary blade housing recess 8, a partial component of the leak flow FL flow into a space Vc between the downstream wall surface 71a of the stator shroud 71 and the upstream end surface 43a of the platform 43, on the downstream side through the clearances.

The leak flow FL, which has flowed into the interior of the space Vc, flows outward in the radial direction Dr along the upstream end surface 43a of the platform 43, and then, collides against the guide surface 45f of the projecting portion 45A. The leak flow FL, which has collided against the guide surface 45f is changed in direction along the guide surface 45f, and is gradually guided inward in the radial direction Dr while going from the downstream side to the upstream side in the central axis direction Da. Accordingly, the leak flow FL forms a vortex T within the space Vc.

Moreover, a partial component of the vortex T deviates from the vortex T, flows to the upstream side in the central axis direction Da and flows into the shroud recess 75A formed to face the projecting portion 45A. If the leak flow FL flows into the shroud recess 75A, the leak flow Fl goes to the upstream side in the central axis direction Da on the inner peripheral wall surface 75a side, and then, is changed in direction from the outer side in the radial direction Dr to the downstream side in the central axis direction Da by hitting the upstream wall surface 75c and the outer peripheral wall surface 75b, and flows out to the downstream side in the central axis direction Da.

The leak flow FL, which has flowed out from the shroud recess 75A to the downstream side in the central axis direction Da, flows out outward in the radial direction Dr from the space Vc to join the main flow FM, and flows to the downstream side in the central axis direction Da.

According to the above-described steam turbine 100 and rotor blade 4, the projecting portion 45A, which projects from the platform 43 toward the upstream side in the central axis direction Da, has the guide surface 45f on the side that faces the inner side in the radial direction Dr. This guide surface 45f curves inward in the radial direction Dr from the base end portion 45s to the tip end portion 45t. Accordingly, the leak flow FL, which flows from the inner side toward the outer side in the radial direction Dr through the gap between the stator shroud 71, the platform 43 of the rotor blade 4, generates the vortex T by hitting the guide surface 45f. By the vortex T being generated, the flow of the leak flow FL from the outer side to the inner side in the radial direction Dr is dissipated. Accordingly, the leak flow FL, which flows out outward in the radial direction Dr from the gap between the stator shroud 71 and the platform 43 of the rotor blade 4, becomes weaker. As a result, the mixed loss when the leak flow FL joins the main flow FM of the steam that alternately passes through the stationary blade main body 70 and the rotor blade main body 40 in the central axis direction Da inside the casing 2 is reduced.

Additionally the shroud recess 75A is formed in the stator shroud 71 at a position facing the projecting portion 45A in the central axis direction Da. According to such a configuration, a portion of the leak flow FL flows into the shroud recess 75A that faces the projecting portion 45A. The leak flow FL becomes weaker by flowing into the shroud recess 75A. As a result, the mixed loss when the leak flow FL joins the main flow FM of the steam is further reduced.

As the mixed loss when the leak flow FL joins the main flow FM of the steam is further reduced in this way, it is possible to improve the performance of the steam turbine 100.

Additionally, in a case where the rotating shaft 1 and the rotor blade 4 thermally elongate in the central axis direction Da more than the stationary blade 7 due to the heat of the steam, at least a portion of the projecting portion 45A is insertable into the shroud recess 75A. Accordingly, interference between the projecting portion 45A and the stator shroud 71 can be suppressed.

Moreover, the projection dimension L1 of the projecting portion 45A from the platform 43 is equal to or less than the recessed dimension L2 of the shroud recess 75A in the central axis direction Da. Thus, for example, even if the rotor blade 4 and the stationary blade 7 is relatively displaced such that the entire projecting portion 45A is inserted into the shroud recess 75A, interference between the projecting portion 45A and the shroud recess 75A can be suppressed.

### Second Embodiment

Next, a second embodiment of the axial flow rotating machine and the rotor blade member related to the invention will be described. Since the second embodiment described below is different from the first embodiment only in the configurations of the first projecting portion 45B, the same portions as those in the first embodiment will be described with the same reference signs, and duplicate descriptions will be omitted.

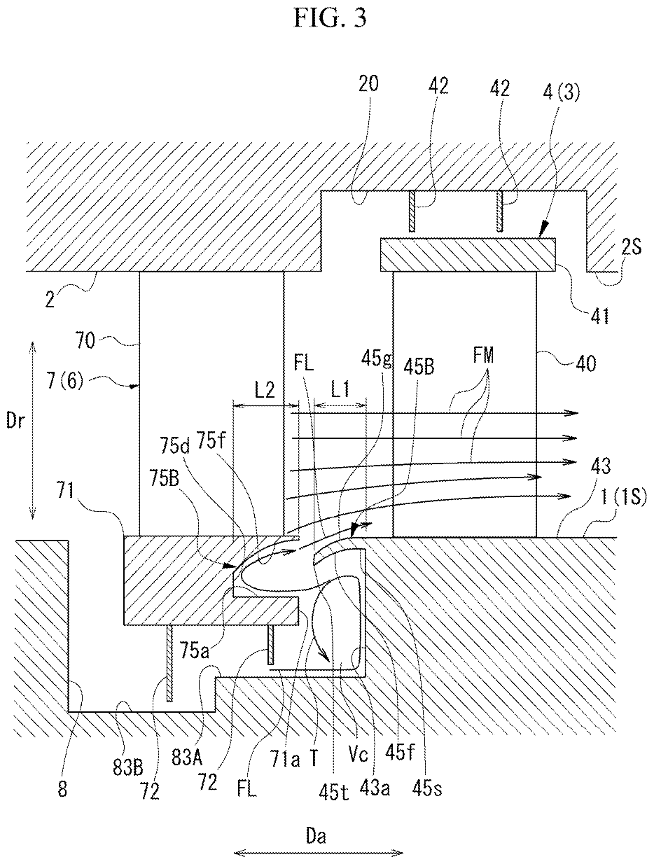

FIG. 3 is an enlarged view of main parts of a steam turbine related to the second embodiment of the invention. As illustrated in FIG. 3, the steam turbine 100 in this embodiment includes further the projecting portion 45B and a shroud recess 75B.

The projecting portion 45B is formed at an intermediate part of the upstream end surface 43a of the platform 43 in the radial direction Dr. The projecting portion 45B is formed so as to project from the upstream end surface 43a of the platform 43 toward the upstream side in the central axis direction Da.

In this embodiment, the projecting portion 45B has the guide surface 45f on a side facing inward in the radial direction Dr. The guide surface 45f is formed so as to gradually curve with a certain curvature inward in the radial direction Dr from the base end portion 45s of the upstream end surface 43a of the platform 43 toward the tip end portion 45t on the upstream side in the central axis direction Da.

Additionally, in this embodiment, the projecting portion 45B has, on a side facing outward in the radial direction Dr, an outer peripheral guide surface 45g that gradually inclines or curves outward in the radial direction Dr from the upstream side toward the downstream side in the central axis direction Da.

The shroud recess 75B is formed in the downstream wall surface 71a of the stator shroud 71. The shroud recess 75B is formed at a position facing the projecting portion 45B in the central axis direction Da so as to be recessed toward the upstream side in the central axis direction Da in the downstream wall surface 71a.

In this embodiment, the shroud recess 75B is formed such that the inner peripheral wall surface 75a on the inner side in the radial direction Dr is parallel to the central axis Ac. In the shroud recess 75B, an upstream wall surface 75d on the upstream side in the central axis direction Da is formed orthogonal to the central axis direction Da. In the shroud recess 75B, an outer peripheral wall surface 75f, which is located on the outer side in the radial direction Dr, gradually curves outward in the radial direction Dr from the upstream side toward the downstream side in the central axis direction Da. It is preferable that the outer peripheral wall surface 75f is formed with approximately the same curvature radius as that the outer peripheral guide surface 45g of the projecting portion 45B.

In the shroud recess 75B, when the rotating shaft 1 and the rotor blade 4 are relatively displaced in the central axis direction Da with respect to the stationary blade 7, at least a portion of the projecting portion 45B is insertable into the shroud recess 75B. Moreover, the projection dimension L1 of the projecting portion 45B in the central axis direction Da from the platform 43 is equal to or less than the recessed dimension L2 of the shroud recess 75B in the central axis direction Da. Accordingly, when the rotating shaft 1 and the rotor blade 4 are relatively displaced in the central axis direction Da with respect to the stationary blade 7, the entire projecting portion 45B is insertable into the shroud recess 75B.

In such a configuration, the steam, which has flowed from the upstream side, alternatively passes through the stationary blade 7 and the rotor blade 4 and flows toward the downstream side to form the main flow FM.

On the other hand, the component, excluding the main flow FM in the steam that has flowed from the upstream side, forms the leak flow FL by flowing toward the interior of the stationary blade housing recess 8. A partial component of the leak flow FL flow into the space Vc between the downstream wall surface 71a of the stator shroud 71 and the upstream end surface 43a of the platform 43.

The leak flow FL, which has flowed into the interior of the space Vc, flows outward in the radial direction Dr along the upstream end surface 43a of the platform 43, and then, collides against the guide surface 45f of the projecting portion 45B. The leak flow FL, which has collided against the guide surface 45f is changed in direction along the guide surface 45f and is gradually guided inward in the radial direction Dr while going from the downstream side to the upstream side in the central axis direction Da. Accordingly, the leak flow FL forms a vortex T within the space Vc.

Moreover, a partial component of the vortex T deviates from the vortex T, flows to the upstream side in the central axis direction Da, and flows into the shroud recess 75B formed to face the projecting portion 45B. If the leak flow FL flows into the shroud recess 75B, the leak flow Fl goes to the upstream side in the central axis direction Da on the inner peripheral wall surface 75a side, and then, is changed in direction from the outer side in the radial direction Dr to the downstream side in the central axis direction Da by hitting the upstream wall surface 75d and the outer peripheral wall surface 75f, and flows out to the downstream side in the central axis direction Da.

The leak flow FL, which has flowed out from the shroud recess 75B to the downstream side in the central axis direction Da, is guided outward in the radial direction Dr toward the downstream side in the central axis direction Da along the outer peripheral guide surface 45g of the projecting portion 45B, flows out outward the radial direction Dr from the space Vc, and joins the main flow FM.

According to the above-described steam turbine 100 and rotor blade 4, similarly to the above first embodiment, the vortex T is generated as the leak flow FL hits the guide surface 45f, and the flow of the leak flow FL from the inner side to the outer side in the radial direction Dr is dissipated. Accordingly, the leak flow FL, which flows out outward in the radial direction Dr from the gap between the stator shroud 71 and the platform 43 of the rotor blade 4, becomes weaker. Additionally, the leak flow FL becomes weaker by flowing into the shroud recess 75B.

In this way, the mixed loss when the leak flow FL joins the main flow FM of the steam that alternately passes through the stationary blade main body 70 and the rotor blade main body 40 in the central axis direction Da inside the casing 2 is reduced. As a result, it is possible to improve the performance of the steam turbine 100.

Additionally, the outer peripheral wall surface 75f of the shroud recess 75B and the outer peripheral guide surface 45g of the projecting portion 45B curve outward in the radial direction Dr from the upstream side toward the downstream side in the central axis direction Da, respectively. Accordingly, the leak flow FL is gradually guided outward in the radial direction Dr from the upstream side toward the downstream side in the central axis direction Da over the outer peripheral wall surface 75f of the shroud recess 75B and the outer peripheral guide surface 45g of the projecting portion 45B. Accordingly, the angle at which the leak flow FL intersects the main flow FM of the steam is smaller than a right angle. As a result, the mixed loss when the leak flow FL joins the main flow FM of the steam is further reduced.

### Modification Example of Second Embodiment

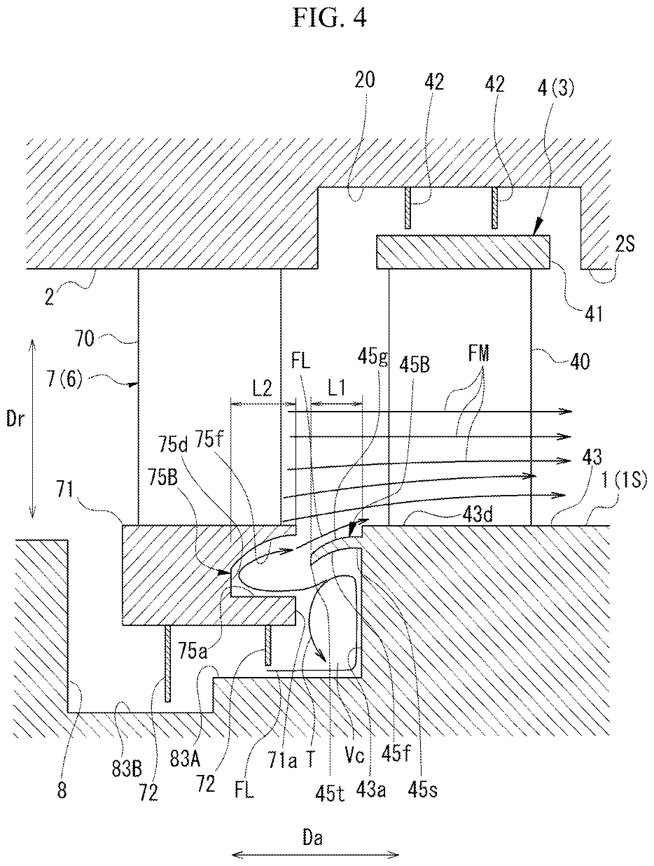

FIG. 4 is an enlarged view of main parts of a steam turbine related to a modification example of the second embodiment of the invention.

As illustrated in this drawing 4, the entire outer peripheral guide surface 45g of the projecting portion 45B may be located closer to the inner side in the radial direction Dr than a surface 43d of the platform 43 that faces outward in the radial direction Dr.

### Third Embodiment

Next, a third embodiment of the axial flow rotating machine and the rotor blade member related to the invention will be described. The third embodiment described below is different from the first and second embodiments only in a configuration including an inner peripheral projecting portion 78 and a platform recess 48. Thus, the same portion as those in the first and embodiments will be described with the same reference signs, and duplicate descriptions will be omitted.

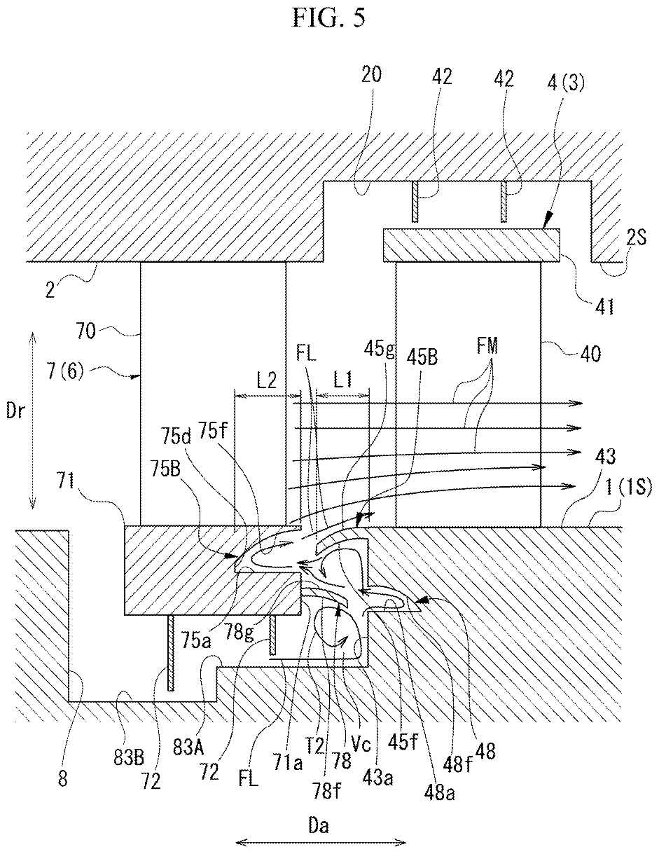

FIG. 5 is an enlarged view of main parts of a steam turbine related to the third embodiment of the invention. As illustrated in FIG. 5, the steam turbine 100 in this embodiment further includes the inner peripheral projecting portion 78 and the platform recess 48 in addition to the projecting portion 45B and the platform recess 48 illustrated in the above second embodiment.

The inner peripheral projecting portion 78 is formed closer to on the inner side in the radial direction Dr than the projecting portion 45B. The inner peripheral projecting portion 78 protrudes from the downstream wall surface 71a of the stator shroud 71 to the downstream side in the central axis direction Da.

In this embodiment, the inner peripheral projecting portion 78 has a guide surface 78f on a side facing inward in the radial direction Dr. The guide surface 78f is formed so as to gradually curve with a certain curvature inward in the radial direction Dr from the downstream wall surface 71a of the stator shroud 71 toward the downstream side in the central axis direction Da. Additionally, in this embodiment, the inner peripheral projecting portion 78 has, on a side facing outward in the radial direction Dr, an outer peripheral guide surface 78g that curves outward in the radial direction Dr from the upstream side toward the downstream side in the central axis direction Da.

Additionally, the platform recess 48 is formed in the platform 43 at a position facing the inner peripheral projecting portion 78 in the central axis direction Da. The platform recess 48 is formed so as to be recessed toward the downstream side in the central axis direction Da with respect to the upstream end surface 43a of the platform 43.

In this embodiment, the platform recess 48 is formed such that an inner peripheral wall surface 48a on the inner side in the radial direction Dr is parallel to the central axis Ac. In the platform recess 48, an outer peripheral wall surface 48f, which is located on the outer side in the radial direction Dr, curves outward in the radial direction Dr from the downstream side toward the upstream side in the central axis direction Da. It is preferable that the outer peripheral wall surface 48f is formed with approximately the same curvature radius as that the outer peripheral guide surface 78g of the inner peripheral projecting portion 78.

In the platform recess 48, when the rotating shaft 1 and the rotor blade 4 are relatively displaced in the central axis direction Da with respect to the stationary blade 7, at least a portion of the inner peripheral projecting portion 78 is insertable into the platform recess 48. Moreover, when the rotating shaft 1 and the rotor blade 4 are relatively displaced in the central axis direction Da with respect to the stationary blade 7, the entire inner peripheral projecting portion 78 is insertable into the platform recess 48.

In such a configuration, the leak flow FL, which has flowed into the interior of the space Vc, flows outward in the radial direction Dr, and then, collides against the guide surface 78f of the inner peripheral projecting portion 78 to form the vortex T2.

Moreover, a partial component of the vortex T2 deviates from the vortex T2, and flows into the platform recess 48 facing the inner peripheral projecting portion 78 on the downstream side in the central axis direction Da. If the leak flow FL flows into the platform recess 48, the leak flow Fl goes to the downstream side in the central axis direction Da on the inner peripheral wall surface 48a side, and then, is sequentially changed in direction from the outer side in the radial direction Dr to the upstream side in the central axis direction Da by hitting the outer peripheral wall surface 48f and flows out to the upstream side in the central axis direction Da.

Similarly to the above second embodiment, the leak flow FL, which has flowed out from the platform recess 48 to the upstream side in the central axis direction Da, sequentially passes through the projecting portion 45B and the shroud recess 75B, flows out outward the radial direction Dr from the space Vc, and joins the main flow FM.

According to the above-described steam turbine 100 and the rotor blade 4 as described above, the leak flow FL hits the inner peripheral projecting portion 78 or flows into the platform recess 48, closer to the inner side in the radial direction Dr than the projecting portion 45B. Accordingly, the flow of the leak flow FL from the inner side to the outer side in the radial direction Dr is further dissipated.

In this way in the space Vc, the inner peripheral projecting portion 78 and the platform recess 48, and the projecting portion 45B and the shroud recess 75B are provided in two or more rows, from the inner side toward the outer side in the radial direction Dr. Accordingly, the mixed loss when the leak flow FL joins the main flow FM of the steam is further reduced. As a result, it is possible to improve the performance of the steam turbine 100.

In addition, the invention is not limited to the above-described respective embodiments, and includes what added various change to the above-described embodiment in the range that does not deviate from the meaning of the invention, and includes various modifications to the above-described embodiments without departing the spirit of the invention. That is, specific shapes, specific configurations, and the like that are described in the embodiments are merely examples, and can be appropriately changed.

For example, although the guide surface 45f, 78f the outer peripheral guide surface 45g, 78g, and the outer peripheral wall surface 48f. 75f are the curved surfaces, these can also be planar inclined surfaces.

Additionally, the above respective embodiments and their modification examples have been described on the basis of the examples in which the steam turbine 100 is applied as the axial flow rotating machine. However, the aspect of the axial flow rotating machine is not limited to the steam turbine 100, and other apparatuses, such as gas turbines and jet engines for aircrafts, can as the axial flow rotating machine.

Additionally, the number of rotor blade rows 3, the number of stationary blade rows 6, the number of fins, and the like in the steam turbine 100 are not limited by the above embodiments, and may be appropriately determined in accordance with design or specification.

Additionally, the configurations of the respective embodiments may be appropriately combined together.

### INDUSTRIAL APPLICABILITY

According to the above axial flow rotating machine and rotor blade member, the mixed loss between the main flow of the working fluid and the leak flow of the working fluid can be reduced, and the performance can be improved.

### REFERENCE SIGNS LIST

1: rotating shaft
1S: outer peripheral surface
2: casing
2S: inner peripheral surface
3: rotor blade row
4: rotor blade (rotor blade member)
5: bearing device
5A: journal bearing
5B: thrust bearing
6: stationary blade row
7: stationary blade
8: stationary blade housing recess
10: intake port
11: exhaust port
20: rotor blade housing recess
40: rotor blade main body
41: rotor shroud
42: rotor blade-side fin
43: platform
43a: upstream end surface
43d: surface
45A, 45B: projecting portion
45f: guide surface
45g: outer peripheral guide surface
45h: outer surface
48: platform recess
48a: inner peripheral wall surface
48f: outer peripheral wall surface
70: stationary blade main body
71: stator shroud
71a: downstream wall surface
72: stator-side fin
75A, 75B: shroud recess
75a: inner peripheral wall surface
75b: outer peripheral wall surface
75c, 75d: upstream wall surface
75f: outer peripheral wall surface
78: inner peripheral projecting portion
78f: guide surface
78g: outer peripheral guide surface
83A, 83B: bottom surface
100: steam turbine (axial flow rotating machine)
Ac: central axis
Da: central axis direction
Dr: radial direction
FL: leak flow
FM: main flow
T, T2: vortex
Vc: space

1. An axial flow rotating machine comprising:
a rotating shaft that is configured to rotate around a central axis;
a rotor blade that has a platform provided on a radially outer side of the rotating shaft and a rotor blade main body provided so as to extend radially outward from the platform;
a tubular casing that is disposed radially outside the rotating shaft and the rotor blade and through which a working fluid flows from an upstream side toward a downstream side in a central axis direction on a radially inner side thereof;
a stationary blade that has a stationary blade main body provided on an upstream side in the central axis direction with respect to the rotor blade and provided so as to extend radially inward from the casing, and a stator shroud provided on a radially inner side of the stationary blade main body; and
a projecting portion that projects from the platform toward the upstream side in the central axis direction,
wherein the projecting portion has, on a side thereof facing the radially inner side, a guide surface that gradually inclines or curves radially inward from the platform toward the upstream side in the central axis direction from a base end portion on the platform side to a tip end portion on the upstream side in the central axis direction.

2. The axial flow rotating machine according to claim 1, further comprising:
a shroud recess that is formed in the stator shroud, faces the projecting portion in the central axis direction, and is recessed toward the upstream side in the central axis direction.

3. The axial flow rotating machine according to claim 2,
wherein an outer peripheral wall surface of the shroud recess, which is located on the radially outer side, gradually inclines or curves radially outward from the upstream side toward the downstream side in the central axis direction.

4. The axial flow rotating machine according to claim 2,
wherein the projecting portion has, on a side thereof facing the radially outer side, an outer peripheral guide surface that gradually inclines or curves radially outward from the upstream side toward the downstream side in the central axis direction.

5. The axial flow rotating machine according to claim 2,
wherein, when the rotating shaft and the rotor blade are relatively displaced in the central axis direction with respect to the stationary blade, at least a portion of the projecting portion is insertable into the shroud recess.

6. The axial flow rotating machine according to claim 5,
wherein a projection dimension of the projecting portion in the central axis direction from the platform is equal to or less than a recessed dimension of the shroud recess in the central axis direction.

7. The axial flow rotating machine according to claim 1, further comprising:
an inner peripheral projecting portion that is formed radially inside the projecting portion and projects from the stator shroud to the downstream side in the central axis direction.

8. The axial flow rotating machine according to claim 7, further comprising: a platform recess that is formed in the platform, faces the inner peripheral projecting portion in the central axis direction, and is recessed toward the downstream side in the central axis direction.

9. A rotor blade member comprising:
a platform that is configured to provide on a radially outer side of a rotating shaft;
a rotor blade main body that is provided so as to extend radially outward from the platform;
a projecting portion that projects from the platform toward an upstream side in a central axis direction of the rotating shaft,
wherein the projecting portion has, on a side thereof facing a radially inner side, a guide surface that gradually inclines or curves radially inward from a base end portion on the platform side to a tip end portion spaced in the central axis direction.

10. The axial flow rotating machine according to claim 4,
wherein an outer peripheral wall surface of the shroud recess, which is located on a radially outer side is formed with the same curvature radius as the outer peripheral guide surface.
